(19) United States
(12) Patent Application Publication
(10) Pub. No.: US 2010/0311504 A1
(43) Pub. Date: Dec. 9, 2010

(54) Controller for a Games System

(76) Inventor: Andrew Deegan, Dublin (IE)

Correspondence Address: NYDEGGER & ASSOCIATES, 348 OLIVE STREET, SAN DIEGO, CA, 92103, US

(21) Appl. No.: 12/664,325

(22) PCT Filed: Jun. 11, 2008
(86) PCT No.: PCT/EP2008/057289

§ 371 Date: May 20, 2010

Related U.S. Application Data
(60) Provisional application No. 60/943,361, filed on Jun. 12, 2007.

(30) Foreign Application Priority Data
Jun. 12, 2007 (GB) 0711286.5

(51) Int. Cl. A63F 13/06

(52) U.S. Cl. 463/38

(57) ABSTRACT

The present application provides a controller for a dual analog controller games system, the controller being provided in the form of an action figure having a base, a torso and at least one member connected to the torso, wherein a first analog stick input is obtained by detecting tilting motion of the torso relative to the base and where a second analog stick input is partially obtained by detecting rotational movement relative to the torso.

This application is filed under the provisions of Patent Cooperation Treaty Application No. PCT/EP2008/057289 having an international filing date of Jun. 11, 2008, which claims priority of GB Application No. 0711286.5 filed on Jun. 12, 2007 and US Non-provisional Application No. 60/943,361 filed on Jun. 12, 2007.

### FIELD OF THE INVENTION

The present invention relates to controllers for games systems, in particular the present invention is directed to dual analog controllers.

### BACKGROUND OF THE INVENTION

A variety of input devices are known for use with games systems including the mouse, keyboards, joysticks and analog sticks. The distinction between a joystick and an analog stick is generally considered that the joystick generally provides a simple output indicating the input direction of the joystick, generally by means of contact switches. In contrast, an analog stick is one where the output indicates the position of the stick and not simply the direction. The position of the stick is generally derived using two orthogonally disposed potentiometers. The most common games controller is a type referred to generically as a dual analog controller. These dual analog controllers comprise two analog sticks, each being controlled respectively by a user using their left and right thumbs. Examples of these devices include the DualShock controllers for SONY PLAYSTATION and the XBOX360 wireless controller. A variety of other manufacturers including NINTENDO also provide dual analog controllers and games systems\consoles which are configured to receive outputs from such controllers.

There is also a class of input devices which allow the user a more realistic interaction. Examples of these types of devices would include steering wheels for car racing games and guns for use in shooting games. In addition, a number of input devices have been proposed which replicate human or animal form. These devices typically employ tilt, inertia and\or contact switches to detect the positions of various limbs. These devices are however extremely complex and require a purpose built interface and games system. As a result, they have to date not been commercially successful. Similar devices are however employed in other fields including animation, where a doll's movements may be detected and replicated on screen.

A recent development in these types of input devices is the Wii™ controller from Nintendo. The Wii™ controller is motion sensitive and can sense motion in a variety of dimensions, including motion sensing of tilting and rotation up and down, tilting and rotation left and right, rotation along the main axis, acceleration up and down, acceleration left and right and\or acceleration toward the screen and away. These allow the Wii™ controller to be used as a sword, a fishing rod, a car steering wheel or a gun. It could be used as a plane that is flown by directing the pad or a character that navigates the screen. This new way of interfacing and interacting with a computer games control is suggested to be more natural than previous methods.

Nonetheless, it would be desirable if a more realistic interface device could be provided which was compatible with existing analog dual mode systems.

### SUMMARY OF THE INVENTION

Accordingly, a first embodiment of the invention provides controllers as detailed in the appended independent claims. Advantageous embodiments are provided in the dependent claims.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

The present invention will now be described with reference to the accompanying drawings in which:

FIG. 1 is a picture of a dual analog controller known from the prior art,

FIG. 2 is a schematic of a prior art circuit for providing an output signal from an analog stick,

FIG. 3 is a front view of an exemplary controller according to the present invention,

FIG. 4 is a side view of the controller of FIG. 3,

FIG. 5 is a perspective view of the controller of FIG. 3,

FIG. 6 is a front view of the controller of FIG. 3 with internal features shown,

FIG. 7 is a perspective view of a further exemplary controller according to the present invention,

FIG. 8 is a front view of the controller of FIG. 7,

FIG. 9 is a side view of the controller of FIG. 7,

FIG. 10 is a perspective view of a further exemplary controller according to the present invention,

FIG. 11 is a front view of the controller of FIG. 10,

FIG. 12 is a side view of the controller of FIG. 10,

FIG. 13 is a perspective view of a further exemplary controller according to the present invention,

FIG. 14 is a front view of the controller of FIG. 13,

FIG. 15 is a side view of the controller of FIG. 13,

FIG. 16 is a perspective view of a further exemplary controller according to the present invention,

FIG. 17 is a front view of the controller of FIG. 16,

FIG. 18 is a side view of the controller of FIG. 16,

FIG. 19 is a view of the controller of FIG. 17 from an alternative perspective,

FIG. 20 is a perspective view of a further exemplary controller,

FIG. 21 is a front view corresponding of FIG. 20,

FIG. 22 is a side view of FIG. 20,

FIG. 23 is a perspective view of the embodiment of FIG. 20 demonstrating articulation,

FIG. 24 and FIG. 25 demonstrate optional features which may be included in the embodiments of FIG. 16 or 20, and

FIGS. 26 and 27 represent perspective and front views of further exemplary embodiments.

FIGS. 28 and 29 illustrate a further embodiment in which a mouse sensor for detecting x-y motion across a surface has been included

### DESCRIPTION OF THE PREFERRED EMBODIMENTS

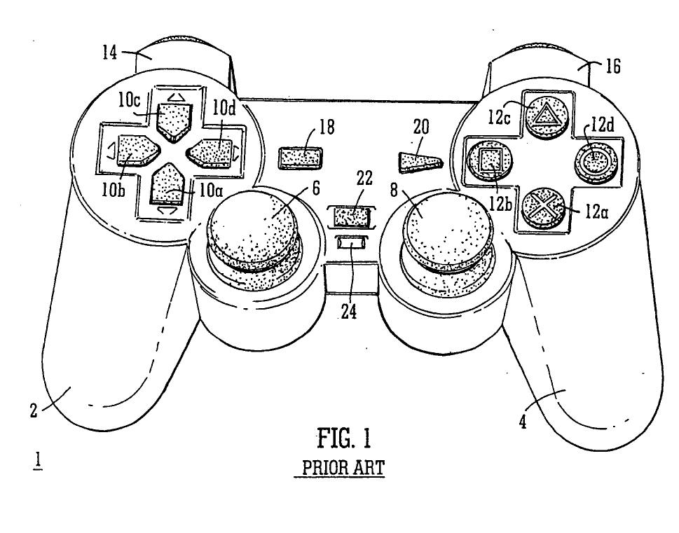

Known types of dual analog controllers, an example one of which is shown in FIG. 1, comprise generally a left hand analog stick 6 and a right hand analog stick 8. A first group of directional buttons 10a, 10b, 10c and 10d are provided on the same general surface as the analog sticks. These directional buttons may be used in place of one or other of the analog sticks or for other purposes selected by the games designer, i.e. one corresponds to forward, one backwards, one left and one right. In some controllers, the user can switch between an analog mode and a non-analog mode by pressing a pre-defined button 22. A LED 24 or other indicator may be provided to indicate whether the controller is in an analog or non-analog mode.

A second group of directional buttons 12a, 12b, 12c, 12d may also be used in place of the second analog stick although conventionally these are employed as special function buttons. The analog sticks and most of the buttons are generally located on the top surface of the controller. Some controllers also have buttons 14, 16 on the front left and front right faces of the controller. Generally, the controller is ergonomically shaped with features 2, 4 to fit within the hands of a user. Typically in a game one of the analog sticks is employed to allow control of a character's motion in a game, with the second analog stick having a subsidiary feature such as, for example, targeting or viewing angle.

Each analog stick is resiliently biased to a generally upright (central) position defining a vertical axis of the stick. Each stick may be tilted away from the central position in a direction along a primary axis (left\right) and\or a secondary axis (forwards\backwards). The first and secondary axes are orthogonal with respect to one and another. In contrast to a joystick the amount of tilt is measured and not simply the direction of tilt. Typically, the amount of tilt in each analog stick is measured by an arrangement of two orthogonally arranged potentiometers. In the first analog stick 6, a first potentiometer 32 provides a measurement for tilt along the first axis and the second potentiometer 34 provides a measurement of tilt along the second axis.

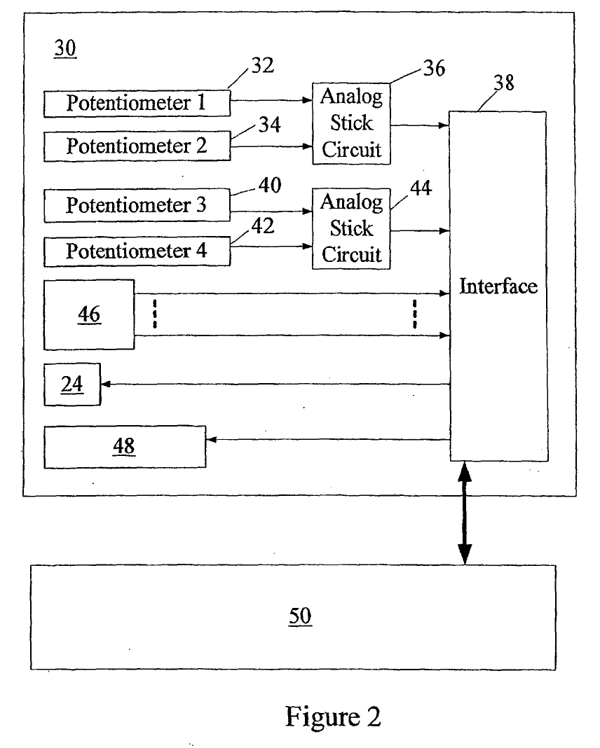

Changes in resistance in the first and second potentiometers as the first stick is tilted are converted by a stick sensor circuit 36 into a corresponding electrical signal, as shown in FIG. 2, to provide a first stick signal.

Similarly, in the case of the second analog stick 8, a third potentiometer 40 provides a measurement for tilt along a first axis and the fourth potentiometer 42 provides a measurement of tilt along a second axis.

Changes in resistance in the third and fourth potentiometers as the second stick is tilted are converted by a second stick sensor circuit 44 into a corresponding electrical signal to provide a second stick signal.

The first and second stick signals are provided through an interface 38 to the games controller 50. It will be appreciated that methods and circuits for performing this conversion and communication are well known and would be familiar to those skilled in the art. Moreover, it will be appreciated that depending on the nature and configuration of the games system, the stick signals may be analog or digital and may comprise two or more individual signals. Additionally, inputs from the various other buttons 46 may be provided through the interface 38 to the games system 50. The interface may also receive a number of outputs from the games system including for example switching an LED 24 on when the controller is in analog mode and for activating a vibrator 48 built into the controller in the event that a specified action happens during a game, for example a player crashing a car in a race game.

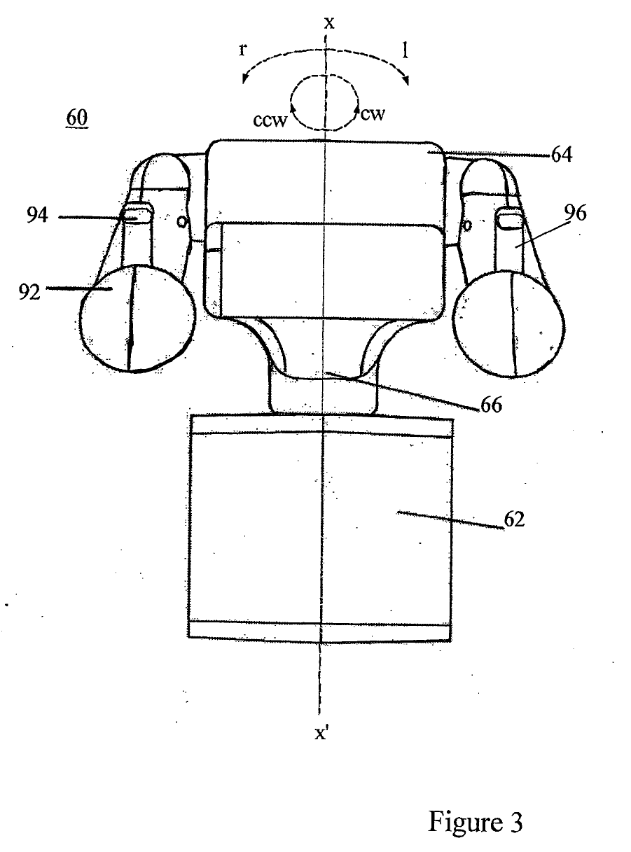

The present application provides a controller, as shown in FIG. 3, which is compatible with and suitable for use as a direct replacement for prior art dual analog controllers. The exemplary controller employs a substantially identical arrangement to the prior art circuit of FIG. 2 (albeit that a reduced number of buttons and\or outputs may be provided). A fundamental difference with the prior art arrangement is however that the potentiometers of the analog sticks are not activated by the user by means of conventionally arranged\positioned analog sticks. The invention will now be described in greater detail with reference to an exemplary embodiment, in which the controller may advantageously be shaped as an action figure which resembles a human, animal or robot-like character.

The advantage of employing such a character is that the controller will have appeal to users in contrast to existing controllers which are largely purely functional in nature. In addition, the operations of the controller may be configured such that a user may intuitively use the action figure in contrast to existing dual analog controllers where the mode of operation must be learnt.

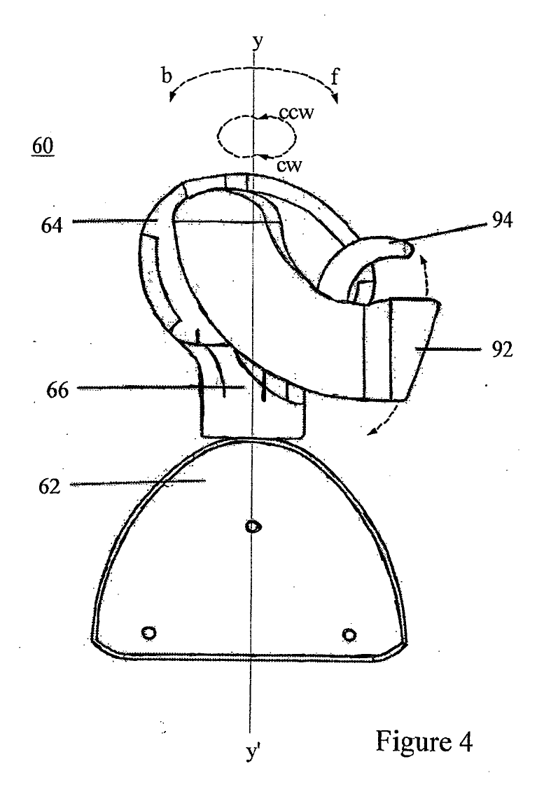

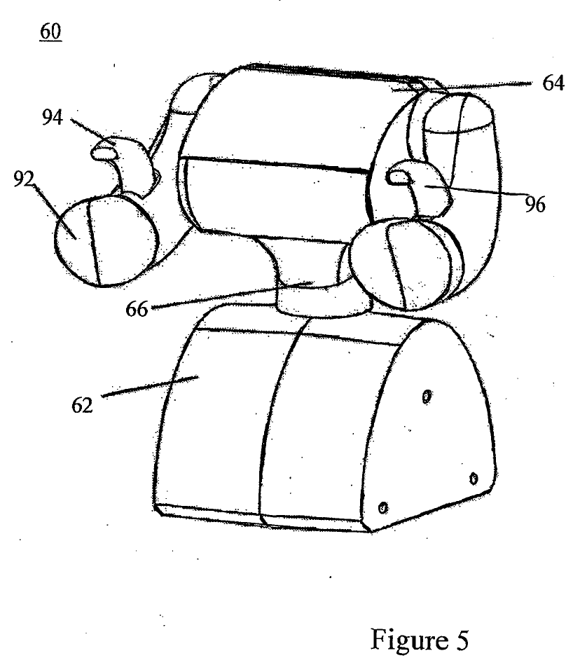

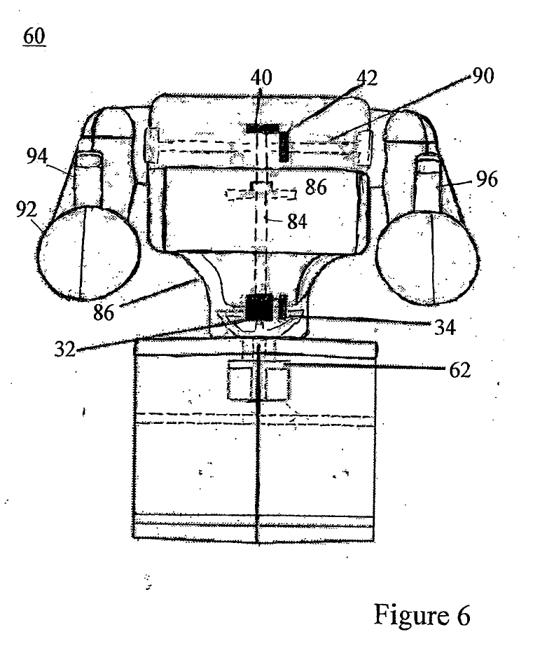

The action figure, as shown in FIGS. 3 to 6, suitably comprises a base portion 62 and a torso portion 64. The base portion may be shaped as legs in the case of a human character or as illustrated as a solid base. In the case of the robotic character the base may be provided with tracks or wheels or decorated to show these. Similarly, the torso portion 64 of the controller may correspond to the upper torso of a human character or robot. A head may or may not be provided on top of the torso. The torso may narrow at a waist area 66 before joining the base 62.The base and torso are resiliently biased to a central vertical axis (x-x′ and y-y′) for example by means of a resilient member provided at the waist and provided in compression between the torso and base and resiliently biasing the torso upright with respect to the base. Nonetheless, the torso may be tilted relative to the base in a forwards/backwards direction (f-b) or a left\right direction (l-r) or any combination between the two away from the central vertical axis by the user. In an exemplary embodiment, the base portion houses an analog stick mechanism as might be employed in a conventional dual analog controller. Suitably the stick mechanism comprises a housing and a stick, with means for a tilting movement of the stick relative to the housing. Suitably, the tilting action of the stick is converted by suitable mechanical means into rotational movements which in turn causes the movement of the potentiometer wipers\contacts in first 32 and second 34 sensors fixed to the housing as would conventionally be employed in prior art devices. It will be appreciated that potentiometers are a particularly cost effective method of measurement but that alternative sensors may also be employed. A first stick sensor circuit 36, as would be employed in the prior art, converts the first and second sensor outputs into a first analog stick signal. The stick mechanism may be conventional in design. However, as the stick mechanism will be operated by a user's hand instead of their thumb, the strength and size of the mechanism may need to be increased accordingly. Alternatively, support may be provided by other structures.

The stick 84 of the stick mechanism may comprise an elongated rod. One or more bearings 86 or similar support structures may be provided for rotatably connecting the torso to the rod, so as to allow rotation of the torso with respect to the stick and thus the base. Thus the torso may be rotated relative to the base around the central axis in a clockwise (cw) or counter clockwise (ccw) direction. This rotation is independent of the previously described tilting action. A third sensor 40 is provided for measuring the relative rotation between the stick\base and the torso portion. The third sensor may be provided on the rod but is preferably provided in the torso, for example, as a potentiometer with the rod operating the wiper\contact arm. The torso and stick connection may be arranged to limit the degree of relative rotation using stops or other suitable mechanical means. The output from the third sensor is provided as a sensor signal to the second analog stick circuit 44. In this respect, it will be appreciated that the sensor has a central operating position representing a neutral input, with rotation in either direction from this central position representing an active input. The torso may be resiliently biased to the central position. The third sensor signal would normally correspond to a tilting action to the left or the right of the second analog stick in a dual analog controller.

Two arms are attached to the torso. The arms are rotatably fixed to the torso, so that they may be rotated upwards or downwards towards the base. The arms may be linked internally so that movement of one arm causes a corresponding movement in the opposite arm. Suitably, the arms are resiliently biased to a central position where they are substantially horizontally disposed from the elbow. The arms may be rotated up or down from this central position. Suitably means may be provided to limit the extent of rotation of the arms by means of stops or other mechanical means.

A fourth sensor 42 is provided, suitably in the torso, for measuring the rotation of the arms from the central position. As with the other sensors, it is suitably a potentiometer. Advantageously, the fourth sensor may be operated by a linkage rod joining the two arms so that movement of either arm actuates the sensor and moves the opposite arm. Suitably the linkage rod operates the contact\wiper arm of the potentiometer. The fourth sensor is connected as a second input to a second stick sensor circuit. This second input would normally correspond to a tilting action forwards or backwards of the second analog stick in a dual analog controller.

The second stick sensor circuit converts the third and fourth sensor outputs into a second analog stick signal, for example, as per the prior art circuit of FIG. 2. In contrast to the prior art, the stick inputs are provided by the movement of two separate objects relative to the torso motion versus a single stick with respect to a stick mechanism. Similarly, the third and fourth sensors and the associated mechanisms are configured to provide a measurement of rotation rather than tilting as per the prior art. The circuitry (including the analog stick circuits and interface) may be provided within the base with a wire or wireless connection provided to the games system 50. In the case of a wireless controller, the base section may also be employed to house batteries for the controller.

In dual analog controllers, a plurality of buttons is typically provided to allow the user to perform certain functions, for example to fire a weapon or to change the current selection of weapon. The present controller provides a button\trigger on one or both of the arms. The trigger is a suitably arranged contact switch such that movement of the trigger causes the switch to close\open depending on the position of the trigger indicating to the games system that the trigger has been pressed. The switch may be resiliently biased to an inactive (off) position. Suitably, the triggers on the left and right arms correspond to separate buttons. Thus, the trigger button on the left hand side arm may be connected to provide a signal for a left hand button on a dual analog controller with the right hand trigger providing a signal for a left hand (front) button. In certain games systems, there may be more than one button on the left\right hand side. For example, in DualShock controllers from Sony, there are two buttons located on the front side on both the left and right hand sides. Optionally, these additional buttons may be implemented as further contact switches using the triggers as actuators. In this arrangement, rearward movement of the trigger from the inactive position would activate the first switch with forward movement of the trigger from the inactive position activating the second switch.

In some games, a button may be employed on the controller, to cause a character to jump in the game. In place of, or in addition to, this button, a sensor may be provided to identify when the controller has been lifted, this may be implemented by means of an inertia sensor to detect upward motion of the controller. Alternatively, a contact switch may be provided to detect when the controller has been lifted off a surface.

Known dual analog controllers typically also have a plurality of other buttons. These buttons may also be implemented on the present controller or alternatively as a separate sub-controller which merely provides the buttons\functions missing from the present controller. When implemented on the controller the buttons may for example be located on the top surface of the torso and\or on the back surface of the torso. Other known features of dual analog controllers include vibration and LED indicators to indicate for example when a controller is in analog mode. It will be appreciated that these features may also be included within the present controller by appropriate positioning.

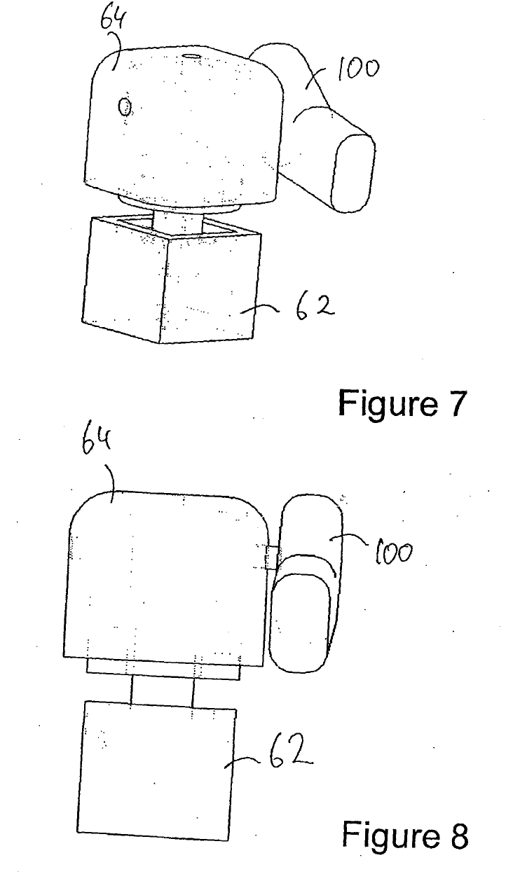

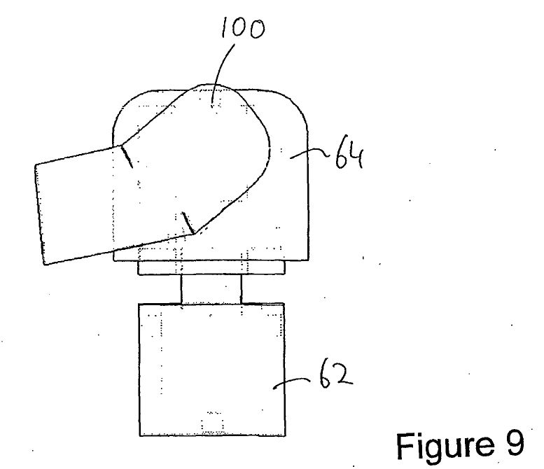

An alternative arrangement is demonstrated in FIGS. 7 to 9 in which similar features described above may be employed. However, in this alternative arrangement, the figure is limited to a single arm 100, which may be on either the right or left hand side of the torso 64, which in turn is connected to a base as before. The arm 100 is suitably mounted to the torso 64 to be free to rotate as described in the previous embodiment. A sensor as previously described is employed to detect this rotation.

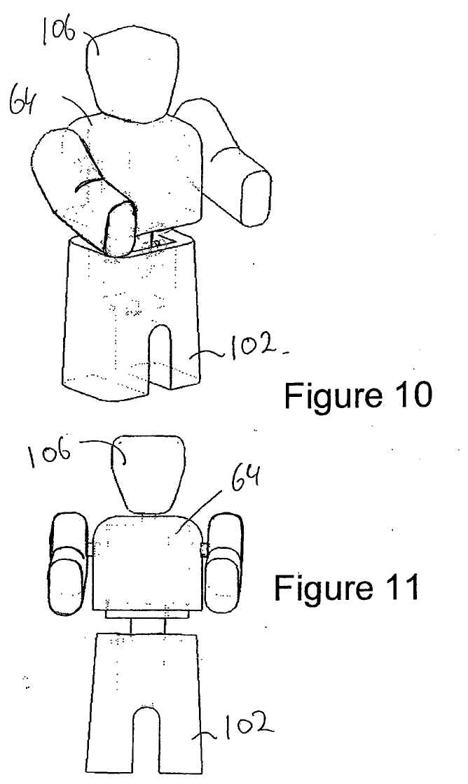

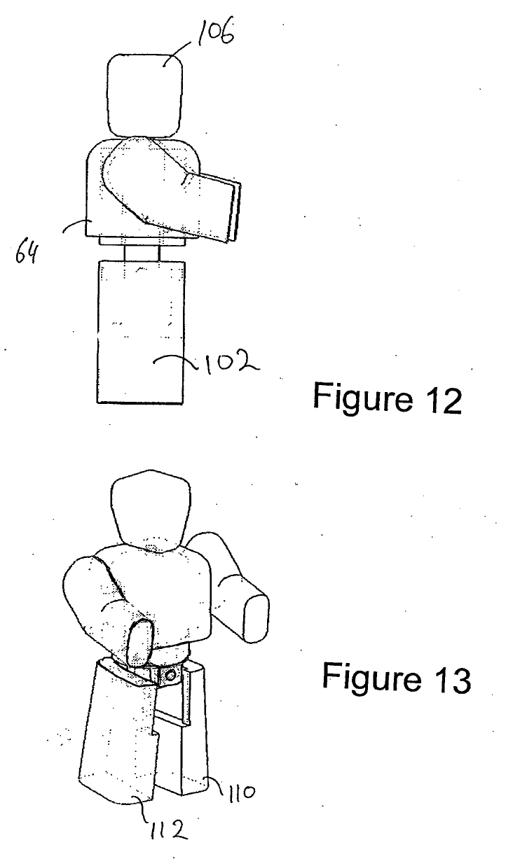

As discussed previously, the embodiments described above may employ a solid base or legs. Thus for example, FIGS. 10 to 12 illustrate an arrangement in which the base 62 has been replaced by a feature 102 resembling legs. To make the figure more human-like, a head 106 has also been included. The head may be fixed to the torso 64. Alternatively, the head may be free to rotate and tilt. Where the head is articulated, one or more of the movements tilt, rotation may be employed as additional inputs by the inclusion of suitable sensors. In addition, the inclusion of a head on the figure provides additional space for the placement of input buttons.

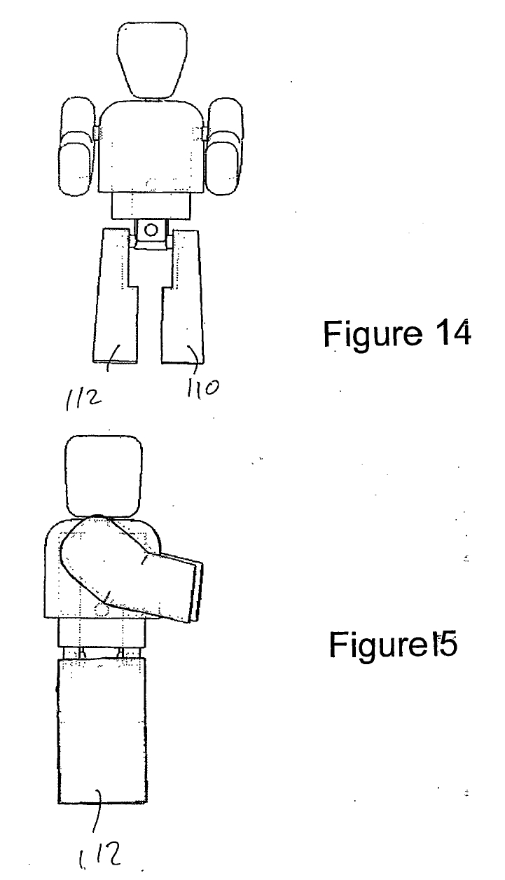

In the embodiments of FIGS. 13 to 15 the base may comprise individual legs which are fixed together but rotatably mounted to a member extending from the torso. In this arrangement, the movement of the legs corresponds to the movement of the base as described above. In a further arrangement, the legs 110, 112 may be free to rotate with respect to one and other as shown. In such a further arrangement, the controller may be manipulated by a user to function more lifelike, i.e. the user may create a walking action by moving the legs with respect to one and other. It will be appreciated that in this arrangement, the sensor arrangement may be employed differently such that measurements of the individual tilting of the legs with respect to the torso may be sensed and provided as an input. Alternatively, sensors may be provided in the legs (e.g. base of the feet) to detect walking motions. The effect of this arrangement is that there are two bases rather than the previous one.

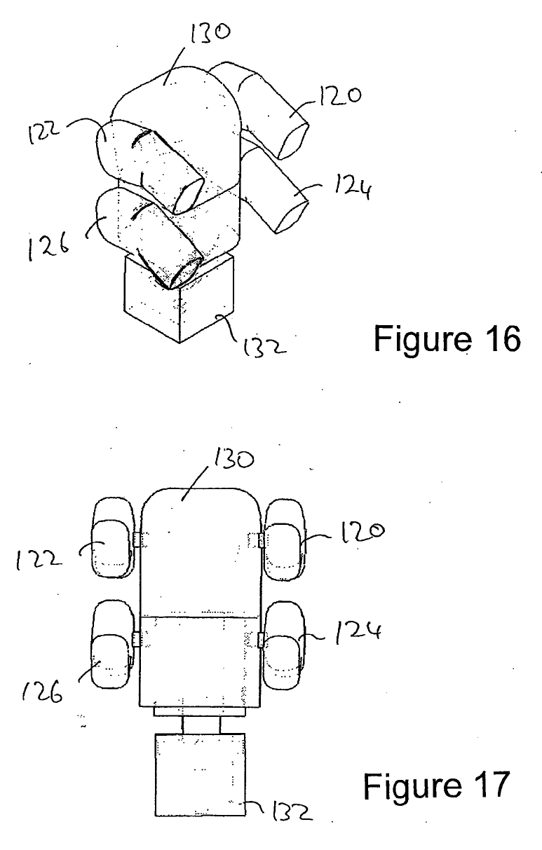

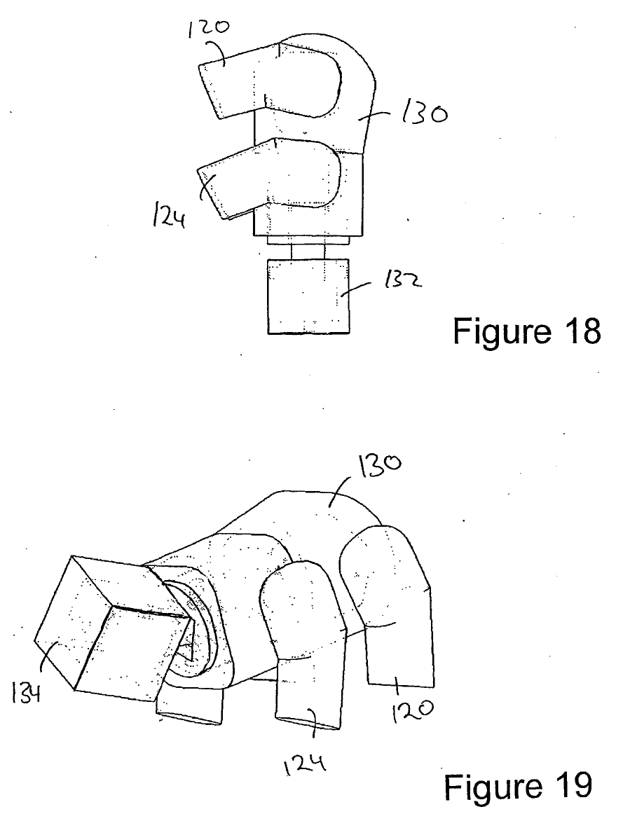

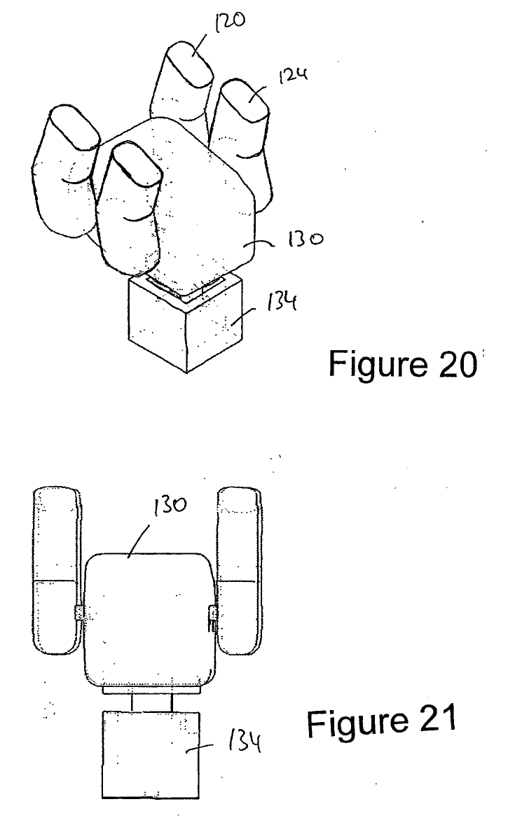

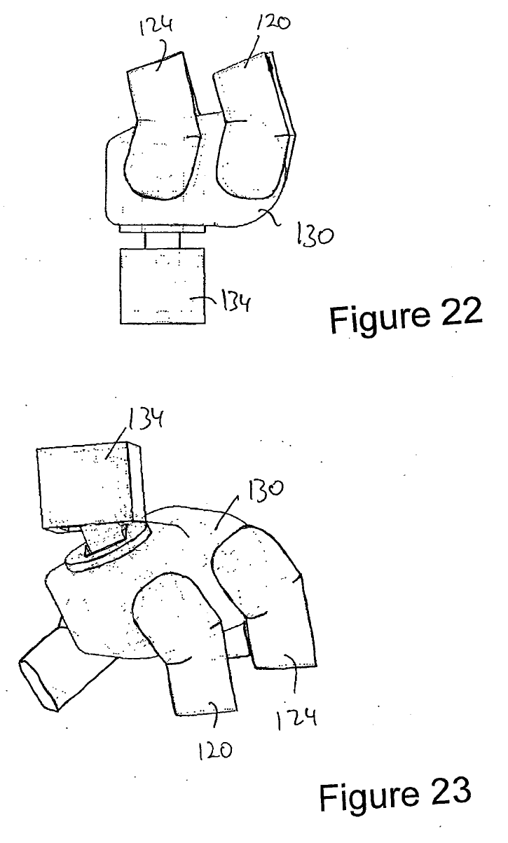

Although the present invention has been described with reference to an exemplary robot or human-like figure, it will be appreciated that it may be implemented in a variety of forms. Thus for example, in FIGS. 16 to 25, a controller in the shape of a four legged animal is illustrated. It will be appreciated that when the controller is in the shape of a four legged animal a variety of possible combinations are available and thus for example the legs 120, 122, 124 and 126 may operate as the previously described arms for the robot or human-like controller with movement detected between the body (torso) of the animal 130 and the legs 120, 122, 124 and 126. Some of the legs may be fixed with motion detected using the other legs. Thus for example, the rear legs may be fixed with motion of the front legs replicating the motion of the arms in the previously described human\robot figures or vice versa. It will be appreciated that a similar sensor may be employed to measure their rotation. Similarly, the head of the animal 132 may function as the base\legs of the previously described human\robot figures. In the arrangement of FIGS. 16, 19 the head, 132 or 134 respectively, of the animal extends from the front of the body 130, i.e. the neck is horizontal as in a sheep, whereas in FIGS. 22 to 25, the neck extends vertically from the body as in a giraffe or horse. Whilst the head of the animal functions as the base\legs of the human\robot-like embodiment in both, it will be appreciated that the orientation when held by a user may be different. Although, the animal figures have been shown with four legs, they are not restricted to this and may have more, e.g. for a centipede or arachnid type figure.

In addition, as described above with respect to FIGS. 13 to 15, opposing legs may be rotated independent of each other, illustrated in FIG. 23, and sensed accordingly.

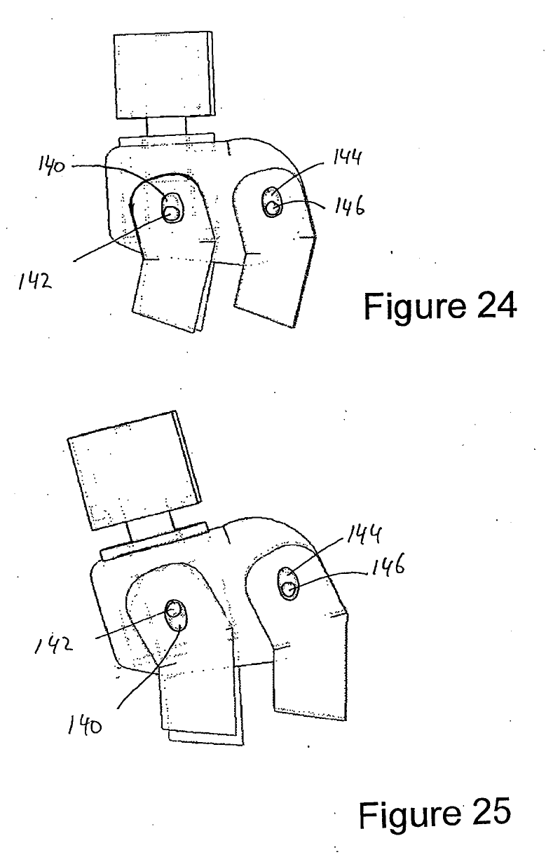

As described previously, in some games, a button may be employed on the controller to cause a character to jump in the game. In place of, or in addition to this button, a sensor e.g. a contact switch may be provided to detect when the controller has been lifted off a surface. Such an arrangement is shown in FIGS. 24 and 25, in which the axle on which opposing legs are free to rotate is retained in a slot. The slot may be in the torso or the legs. The axle and slot are shaped to co-operate such that axle may move along the slot. In one arrangement, the axle is biased toward the bottom of the slot by the weight of the legs. In this arrangement, if the animal was placed on a flat surface the weight of the torso would bias the axle to the top of the slot. A suitable contact sensor could be employed to measure whether the axle was positioned at the top (axle 142 in FIG. 25) or the bottom of the slot (axle 142 in FIG. 24) as a further controller input. As an alternative or in addition to the use of gravity to bias the axle, a resilient member, e.g. a spring, may be provided to bias the axle to a particular position. It will be appreciated that such an arrangement may also be employed in the human\robot-like figures previously described. In the case of the four legged animal, the positions of the front and rear axles may be sensed independently which may provide more useful inputs to a controller where a game provides for this. Thus as illustrated in FIG. 25, weight has been applied to the front legs but not the rear legs.

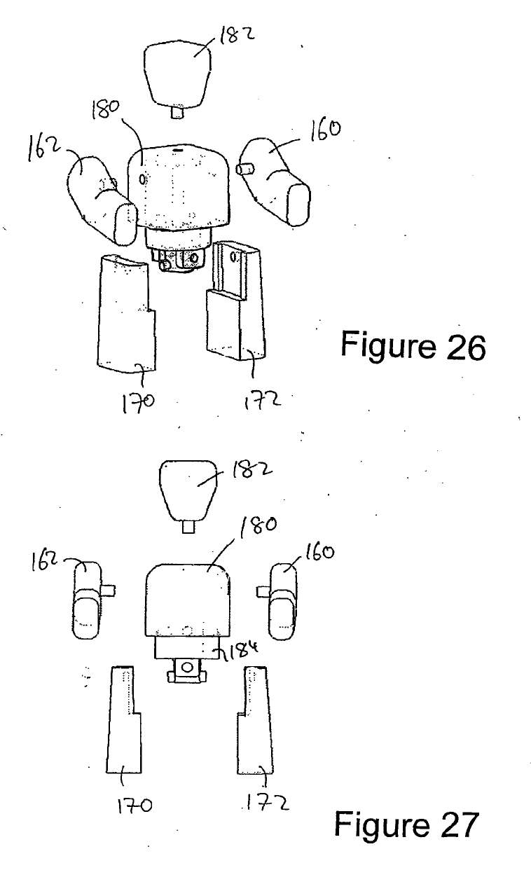

It will be appreciated that in the case of the above described embodiments, the sensors may be arranged to be within the torso, since the relative motion is generally between the torso and another object, e.g. base, arm, etc. Accordingly, in a further embodiment shown in FIGS. 26 and 27, a modular construction of controller is provided in which a torso is provided with the sensors etc. and suitable plug-socket arrangements to allow arms, legs and heads to be removably mounted to create different characters. In this arrangement, the sensor element may be provided as an inner body 184 having an arrangement to allow a shell 180 to be placed around it. In this arrangement, completely different characters may be provided to users separate from the primary controller which could be housed in the inner body 184. In the exemplary arrangement of FIGS. 26 and 27, the arms 160, 162 are shown with plugs with corresponding sockets provided on the torso 180, 184 and the torso having plugs for corresponding sockets on the legs 170, 172. The head 182 may be mounted in a similar fashion.

It will be appreciated that further functionality may also be included such that feedback from the games system may cause specific functionality on the controller in a similar fashion to the vibration present in most dual action controllers. However, the feedback functionality need not be restricted to this and may for example include light or sound effects, motion of a particular part, e.g. of the head. In the case of the modular assembly of FIGS. 26 and 27, it may also include releasing other parts, e.g. arms\head from the torso for example as a character in a game incurs damage. Similarly, this may be extended to include other features thus for example a controller may be provided with a releasable mounted feature in the shape of a shield. When a character loses their shield in a game, an actuator in the controller could be actuated to cause the release of the shield.

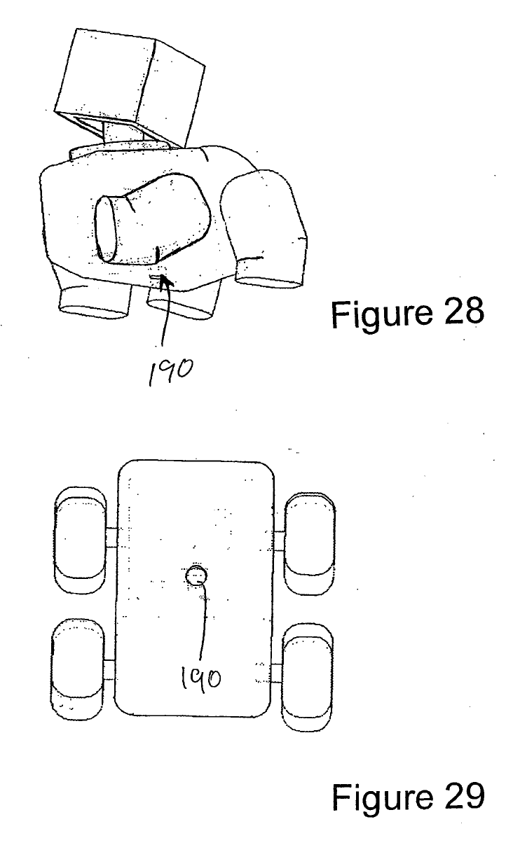

A further embodiment shown in FIGS. 28 and 29 includes a mouse sensor, e.g. a two dimensional infra-red motion sensor for detecting horizontal movement of the figure across a surface. These additional inputs may be also be used as inputs to a games system or indeed any computing system. In fact, it will be appreciated that whilst the above have been described with reference to their use as a games controller, they may be used as general input devices to a suitably configured computing system.

A further option is to employ the head to perform the digital pad functions of the first group of directional buttons 10a, 10b, 10c, 10d or second group of directional buttons 12a, 12b, 12c, 12d, with motion of the head forward, backwards, or to the sides actuating corresponding switches to those of the directional buttons.

The above embodiments are intended to be exemplary rather than exhaustive and it will be appreciated by those skilled in the art that a variety of alternatives are possible. Thus for example, the base could be replaced with the torso, with a head replacing the torso and movement of ears or another feature on the head used for the function of the arms.

The words comprises/comprising when used in this specification are to specify the presence of stated features, integers, steps or components but does not preclude the presence or addition of one or more other features, integers, steps, components or groups thereof.

While the particular Controller for a Games System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A controller for use with a games system, the games system being configured to receive inputs from a dual analog controller comprising at least two analog sticks, the controller comprising:
a base,
a torso tiltably and rotatably mounted with respect to said base,
at least one arm rotatably connected to said torso,
first and second sensors configured to detect tilting motion of the torso relative to the base, a first analog stick circuit accepting the first and second sensor outputs and providing a first analog stick output signal, a third sensor configured to detect rotational movement of the torso relative to the base,
a fourth sensor configured to detect movement of the arm relative to the torso, a second analog stick circuit accepting the third and fourth sensor outputs and providing a second analog stick output signal.

2. A controller according to claim 1, wherein the first and second sensors are orthogonally arranged.

3. A controller according to claim 1, wherein the first and second sensors are potentiometers.

4. A controller according to claim 1, wherein the torso is resiliently biased to central axis of said base.

5. A controller according to claim 1 wherein the torso is mounted on a member extending from said base.

6. A controller according to claim 5, wherein the member is tiltably mounted to said base.

7. A controller according to claim 5, wherein the torso is rotatably mounted on said member.

8. A controller according to claim 5, wherein the third sensor is positioned in the torso at the top of the member.

9. A controller according to claim 1, wherein the first and second sensors are positioned in the base at the bottom of the member.

10. A controller according to claim 1 wherein one or more controller buttons are provided on the one or both arms.

11. A controller according to claim 1, wherein one or more controller buttons are provided on the top surface of the torso.

12. A controller according to claim 1, wherein one or more controller buttons are provided on the front or rear surface of the torso.

13. A controller according to claim 1, wherein the controller is in the shape of a human figure and the torso of the human figure corresponds to the torso of the controller.

14. A controller according to claim 13, wherein an arm of the figure corresponds to the arm of the controller.

15. (canceled)

16. (canceled)

17. (canceled)

18. A controller according to claim 1, further comprising a head which is tiltably mounted to the torso and further comprising one or more switches for detecting the orientation of the head to the torso.

19. (canceled)

20. A controller according to claim 18, wherein the head is resiliently biased to a central position.

21. A controller according to claim 1, wherein the controller is in the shape of an animal the torso of the animal figure corresponds to the torso of the controller.

22. (canceled)

23. (canceled)

24. (canceled)

25. (canceled)

26. A controller according to claim 1 further comprising a sensor for measuring the movement of the controller relative to a surface in at least one direction.

27. A controller according to claim 26, where the relative movement is measured in two directions.

28. (canceled)

29. (canceled)

30. A modular controller comprising a controller according to claim 1, wherein the at least one arm is removably mounted to the controller.

31. A modular controller according to claim 30, wherein the base is removably mounted to the controller.

32. A controller for a dual analog controller games system, the controller being provided in the form of an action figure having a base, a torso and at least one member connected to the torso, wherein a first analog stick input is obtained by detecting tilting motion of the torso relative to the base and where a second analog stick input is partially obtained by detecting rotational movement relative to the torso.
